(19) United States
(12) Patent Application Publication
(10) Pub. No.: US 2009/0309845 A1
(43) Pub. Date: Dec. 17, 2009

(54) TOUCH WINDOW

(75) Inventors: Kuang-Ta CHEN, Taoyuan County (TW); Tai-an Tsui, Taipei City (TW); Wen-Jung Wu, Taipei County (TW); Hsing-Yu Chuang, Taipei County (TW); Wei-Chih Chen, Hsinchu City (TW); Yu-Yuan Lin, Taoyuan County (TW)

Correspondence Address: RABIN & Berdo, PC, 1101 14TH STREET, NW, SUITE 500, WASHINGTON, DC, 20005, US

(73) Assignee: Transtouch Technology Inc., Taoyuan County (TW)

(21) Appl. No.: 12/469,398

(22) Filed: May 20, 2009

(30) Foreign Application Priority Data
Jun. 13, 2008 (TW) 097122300
Jun. 24, 2008 (TW) 097123610
Jul. 4, 2008 (TW) 097211999

(51) Int. Cl. G06F 3/041

(52) U.S. Cl. 345/173

(57) ABSTRACT

A touch window including a first transparent substrate, a second transparent substrate, a first conductive film and a pad is provided. The second transparent substrate is disposed on one side of the first transparent substrate, and the area of the first transparent substrate is larger than that of the second transparent substrate. The first conductive film is disposed on the second transparent substrate and is located between the first transparent substrate and the second transparent substrate. The pad is disposed on the same side of the first transparent substrate as the second transparent substrate being disposed.

This application claims the benefit of Taiwan application Serial No. 97122300, filed Jun. 13, 2008, Taiwan application Serial No. 97123610, filed Jun. 24, 2008, and Taiwan application Serial No. 97211999, filed Jul. 4, 2008 the subject matter of which is incorporated herein by reference.

### BACKGROUND OF THE INVENTION

1. Field of the Invention

The invention relates in general to a touch window, and more particularly to a touch window which increases the convenience of the manufacturing process.

2. Description of the Related Art

Along with advances in the flat display technology, a flat display has had significant progress in display effect. Furthermore, the cost of the flat display is reduced as the advances in the technology of the manufacturing process, so that the flat display has become more and more popular in the market. In order to increase the convenience in use, a touch panel is further integrated into the flat display and is used in various electronic devices recently. For example, the touch panel can be used in a mobile phone, so that a user can directly click on the touch panel to operate various functions. Thus, an operation mode which is more convenient and humanized is provided.

The elaboration herein is exemplified by a capacitive touch panel and a resistive touch panel. The structure of a capacitive touch panel mainly includes a substrate. A conductive film processed by chemical or laser etching to fit the requirements of the products is disposed on the top surface of the substrate, and another conductive film can be disposed on the bottom surface of the substrate according to the different applications. In addition, the structure of a resistive touch panel mainly includes a top substrate, a bottom substrate and a bonding layer. The top substrate and the bottom substrate are bonded together by the bonding layer (such as a double-sided adhesive or high polymer adhesive). A conductive film is disposed on the top substrate, and another conductive film is disposed on the bottom substrate.

In order to make the appearance of touch panel more attractive and has higher commercial value, an adhesive layer (such as an optical adhesive or a high polymer adhesive) is further coated or bonded on the substrate of the capacitive touch panel or the top substrate of the resistive touch panel to bond the substrate with a flexible film. Thus, the touch panel and the flexible film must have the same shape and size.

Besides, regarding the selection of material, the substrate of the capacitive touch panel and the bottom substrate of the resistive touch panel are normally made of poly-carbonate (PC) or glass. The substrate made of PC is easy to process but is poor in light transmittance. In addition, the substrate made of glass has excellent light transmittance but is difficult to be processed. Moreover, no matter the substrate is made of PC or glass, the conductive film disposed on the surface of the substrate may easily be damaged during the manufacturing process. As a result, the yield in the manufacturing process is decreased.

Moreover, when the touch panel is used in electronic devices with different specifications and sizes, the positions of vias at the substrate need to be changed and the size of the substrate needs to be changed correspondingly. Therefore, not only the cost is consumed but the efficiency of the manufacturing process is also reduced.

### SUMMARY OF THE INVENTION

The invention is directed to a touch window. With the disposition of a pad, a substrate of the touch window can be used in products having different specifications without changing the size or shape of the substrate.

According to the present invention, a touch window including a first transparent substrate, a second transparent substrate, a first conductive film and a pad is provided. The second transparent substrate is disposed on one side of the first transparent substrate. The area of the first transparent substrate is larger than that of the second transparent substrate. The first conductive film is disposed on the second transparent substrate and is located between the first transparent substrate and the second transparent substrate. The pad is disposed on the same side of the first transparent substrate as the second transparent substrate being disposed.

The invention will become apparent from the following detailed description of the preferred but non-limiting embodiments. The following description is made with reference to the accompanying drawings.

### BRIEF DESCRIPTION OF THE DRAWINGS

FIG. 1 shows a touch window according to a first embodiment of the present invention;

FIG. 2 shows a three-dimensional diagram of the touch window in FIG. 1;

FIG. 3 shows the first transparent substrate, the second transparent substrate and the pad in FIG. 2;

FIG. 4 shows the disposition of the pad surrounding the second transparent substrate;

FIG. 5 shows a touch window according to a second embodiment of the present invention;

FIG. 6 shows a three-dimensional diagram of the touch window in FIG. 5;

FIG. 7 shows the conductive film directly formed on the first transparent substrate;

FIG. 8 shows a touch window according to a third embodiment of the present invention; and

FIG. 9 shows a three-dimensional diagram of the touch window in FIG. 8.

### DETAILED DESCRIPTION OF THE INVENTION

According to a preferred embodiment of the present invention, a touch window is provided. A pad is used for allowing the same size transparent substrate to be disposed in electronic products with different specifications so as to increase the application flexibility of the touch window. Some preferred embodiments of the present invention are disclosed below for elaboration. However, the embodiments are for elaboration only, the scope of the present invention is not limited thereto. Also, some components are omitted in the drawings for highlighting the technical features of the present invention.

### First Embodiment

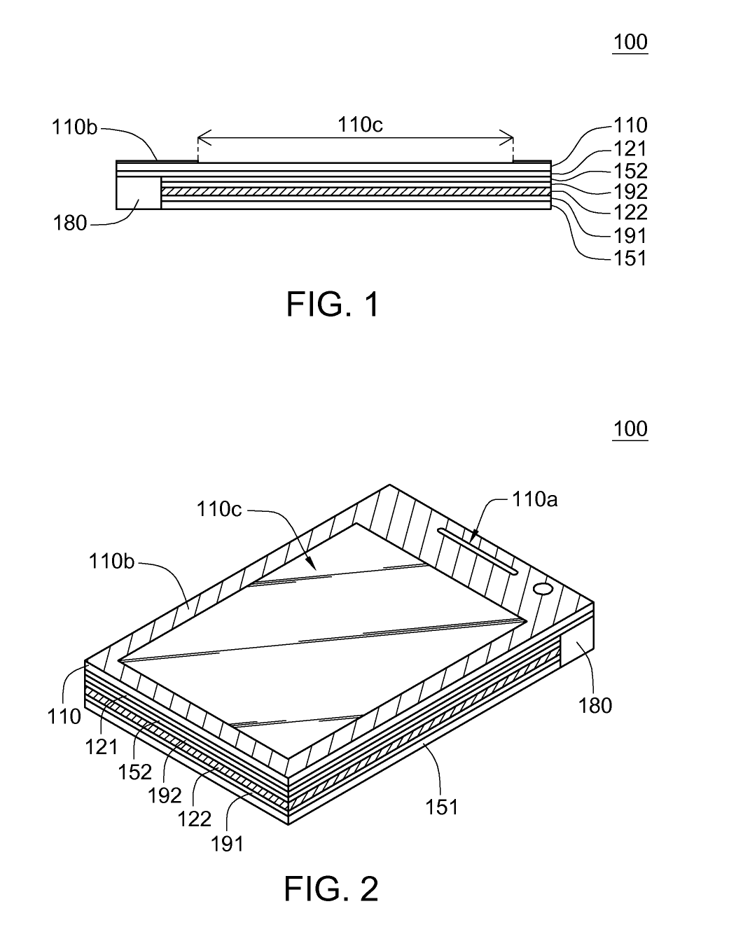

Referring to both FIG. 1 and FIG. 2, a touch window according to a first embodiment of the present invention is shown, and a three-dimensional diagram of the touch window in FIG. 1 is shown. The touch window 100 includes a first transparent substrate 110, a second transparent substrate 151, a third transparent substrate 152, two adhesive layers 121 and 122, two conductive films 191 and 192 and a pad 180.

In the present embodiment of the invention, the area of the first transparent substrate 110 is larger than those of the second transparent substrate 151 and the third transparent substrate 152. The third transparent substrate 152 and the second transparent substrate 151 are sequentially disposed on one side of the first transparent substrate 110. The conductive film 191 is disposed on the second transparent substrate 151, and the conductive film 192 is disposed on the third transparent substrate 152. The conductive film 191 faces the conductive film 192. The adhesive layer 121 is disposed between the third transparent substrate 152 and the first transparent substrate 110 for bonding the third transparent substrate 152 and the first transparent substrate 110. The adhesive layer 122 is disposed between the second transparent substrate 151 and the third transparent substrate 152 for bonding the second transparent substrate 151 and the third transparent substrate 152, so that the conductive films 191 and 192 are located on two opposite surfaces of adhesive layer 122. The pad 180 is disposed through the adhesive layer 121 on the same side of the first transparent substrate 110 as the second transparent substrate 151 and the third transparent substrate 152 being disposed. In addition, the pad 180 is, for example, adjacent to the second transparent substrate 151 and the third transparent substrate 152. In the present embodiment of the invention, the adhesive layers 121 and 122 are, for example, an optical adhesive, a double-sided adhesive or a high polymer adhesive.

In a preferred embodiment of the present invention, the second transparent substrate 151 and the third transparent substrate 152 can be made of glass so as to increase the light transmittance of the touch window 100. However, the materials of the second transparent substrate 151 and the third transparent substrate 152 are not limited thereto. The second transparent substrate 151 and the third transparent substrate 152 can also be made of plastics material such as poly-carbonate (PC), poly-ethylene terephthalate (PET) or other commonly used light transmitting material. The first transparent substrate 110 is made of a flexible material or a hard transparent material. The flexible material is, for example, PET, and the hard transparent material is, for example, plastics or glass. Moreover, the conductive films 191 and 192 can be respectively formed on the second transparent substrate 151 and the third transparent substrate 152 by sputtering or evaporating.

As indicated in FIG. 1 and FIG. 2, the surface of the first transparent substrate 110 is coated with an opaque layer 110b partly covering the surface of the first transparent substrate 110. A light transmitting area 110c is formed on a part of the first transparent substrate 110 which is not covered by the opaque layer 110b. The light transmitting area 110c substantially corresponds to the second transparent substrate 151 for exposing a part of the second transparent substrate 151.

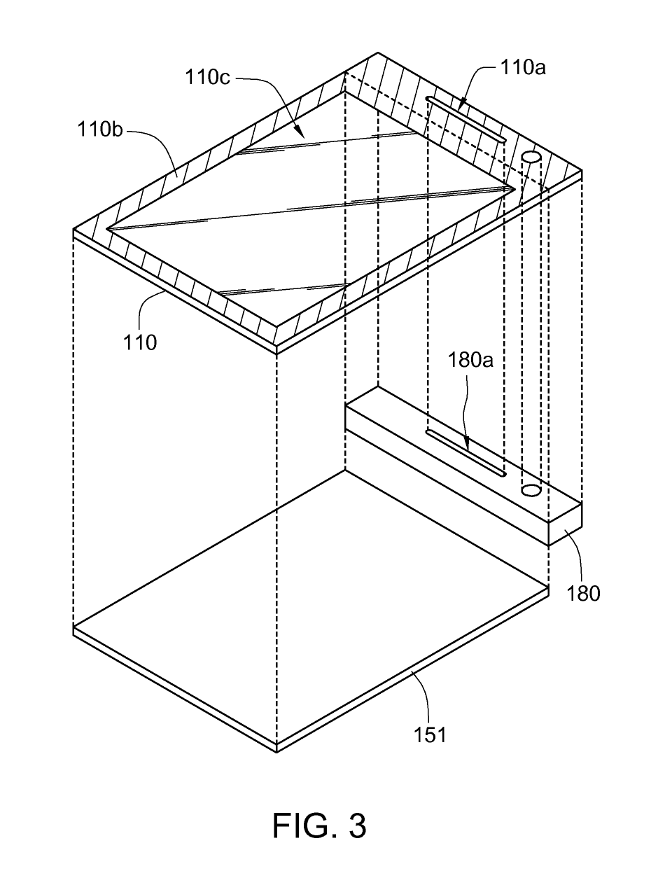

Furthermore, the area of the first transparent substrate 110 of the present embodiment of the invention is larger than those of the second transparent substrate 151 and the third transparent substrate 152. The pad 180 made of an easy-to-process material such as plastics or glass is disposed on the first transparent substrate 110 through the adhesive layer 121 located on the surface of the first transparent substrate 110. In the present embodiment of the invention, the pad 180 is adjacent to the second transparent substrate 151 and the third transparent substrate 152. The disposition of the pad 180, the second transparent substrate 151 and the third transparent substrate 152 is exemplified below by the second transparent substrate 151 and the pad 180. FIG. 3 shows the first transparent substrate, the second transparent substrate and the pad in FIG. 2. The second transparent substrate 151 and the pad 180 are correspondingly disposed on the same side of the first transparent substrate 110. Preferably, the second transparent substrate 151 and the pad 180 are disposed on the side of the first transparent substrate 110 opposite to the side that the opaque layer 110b is disposed. The first transparent substrate 110 has several vias 110a located at a part of the first transparent substrate 110 where the pad 180 is disposed. The pad 180 has several vias 180a. The number, shape and location of the vias 180a correspond to those of the vias 110a. When the touch window 100 is used in a mobile phone, the vias 110a and 180a are used for exposing components of the mobile phone such as a receiver or a camera. During the manufacturing process of the touch window 100, the vias 110a and 180a are only respectively formed on the first transparent substrate 110 and the pad 180, so the sizes and shapes of the second transparent substrate 151 and the third transparent substrate 152 as well as the quality of the conductive films disposed thereon are maintained. Thus, the manufacturing cost is reduced and the manufacturing efficiency is increased.

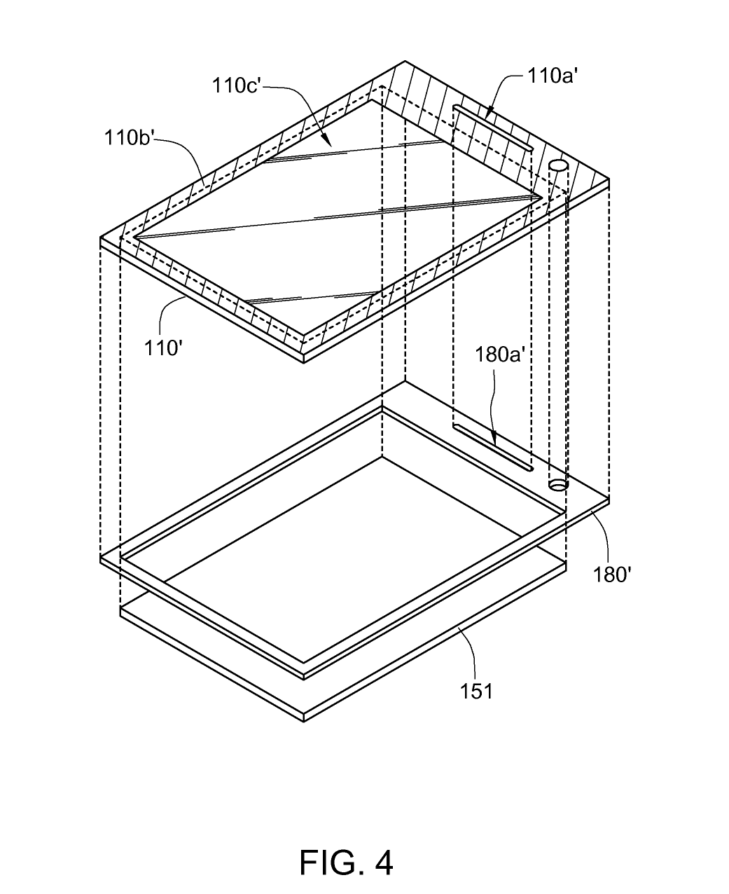

The pad 180 of the touch window 100 is adjacent to the second transparent substrate 151 and the third transparent substrate 152 in the above disclosure. However, the disposition of the pad and two transparent substrates is not limited thereto. The disposition of the pad can be changed according to the requirements of the product design. For example, the pad can surround two transparent substrates. The disposition of the pad 180′, the second transparent substrate 151 and the third transparent substrate 152 are exemplified below by the second transparent substrate 151 and the pad 180′ in FIG. 4. Referring to FIG. 4, the disposition of the pad surrounding the second transparent substrate is shown. The second transparent substrate 151 and the pad 180′ are disposed on the same side of the first transparent substrate 110′, and the pad 180′ surrounds the second transparent substrate 151. In addition, the light transmitting area 110c′ located at a part of the first transparent substrate 110′ which is not covered by the opaque layer 110b′. The light transmitting area 110c′ substantially corresponding to the second transparent substrate 151 is used for exposing at least a part of the second transparent substrate 151. The first transparent substrate 110′ has several vias 110a′ located at the part of the first transparent substrate 110′ corresponding to the outside of the light transmitting area 110c′. The pad 180′ has several vias 180a′. The number, shape and location of the vias 180a′ correspond to those of the vias 110a′. With the disposition indicated in FIG. 4, vias do not need to be formed at the second transparent substrate 151 and the third transparent substrate 152 so as to maintain the size and shape of the second transparent substrate 151 and the third transparent substrate 152 as well as the quality of the conductive films disposed thereon. Thus, the manufacturing cost is reduced and the manufacturing efficiency is increased.

As shown in both FIG. 3 and FIG. 4, under the condition of using the same second transparent substrate 151 and the same third transparent substrate 152, the silver epoxy (not shown) between the edges of the second transparent substrate 151 and the third transparent substrate 153 is not exposed from the light transmitting areas 110c and 110c as the areas of the first transparent substrates 110 and 110′, the disposition of the pads 180 and 180′ and the range of the light transmitting areas 110c and 110c′ are appropriately changed. The touch window of the present embodiment of the invention can be used in the electronic devices having different specification without changing the shape of the second transparent substrate 151 and the third transparent substrate 152 and forming vias at the second transparent substrate 151 and the third transparent substrate 152. Therefore, the conductive films 191 and 192 (illustrated in FIG. 2) respectively disposed on the second transparent substrate 151 and the third transparent substrate 152 are not damaged. Furthermore, the step of forming the conductive films 191 and 192 (such as the sputtering process) can be performed on a large size transparent substrate before cutting, so that the efficiency of the manufacturing process is increased.

The touch window 100 is exemplified by a resistive touch window. As indicated in FIG. 1 and FIG. 2, the conductive film 192 is, for example, used as a top electrode layer of the resistive touch window, and the conductive film 191 is, for example, used as a bottom electrode layer of the resistive touch window. The adhesive layer 122 is for bonding the second transparent substrate 151 and the third transparent substrate 152, so that the conductive film 191 and 192 are bonded on the two opposite surfaces of adhesive layer 122, respectively. In addition, the third transparent substrate 152 can be, for example, made of a flexible material. With the disposition of the adhesive layer 121, the third transparent substrate 152 is bonded on the first transparent substrate 110. Thus, when the first transparent substrate 110 and the third transparent substrate 152 are both made of a flexible material, the first transparent substrate 110 and the third transparent substrate 152 can be flat easily during the bonding process, hence further improving the operation and appearance of the product.

### Second Embodiment

The present embodiment of the invention differs from the first embodiment in the size, number and disposition of conductive films and transparent substrates. Particularly, the touch window of the present embodiment of the invention includes a second transparent substrate whose area is smaller than that of a first transparent substrate and a third transparent substrate whose area is substantially equal to that of the first transparent substrate. As for other components and steps, the same numbers are used and are not repeatedly described herein.

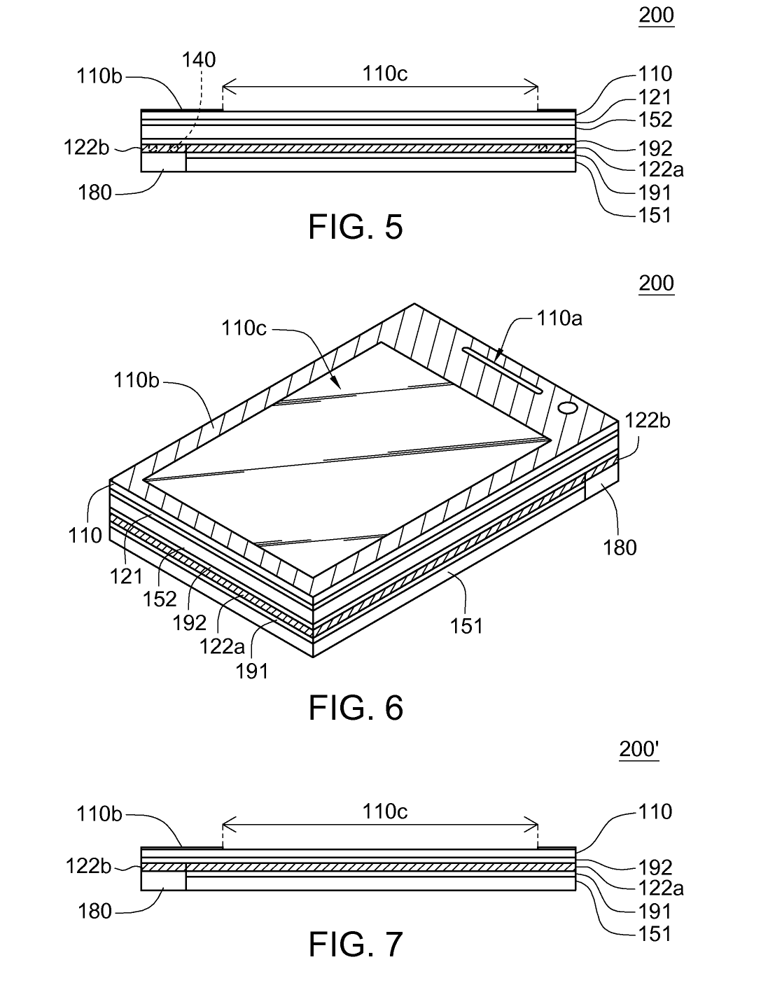

Referring to both FIG. 5 and FIG. 6, a touch window according to a second embodiment of the present invention is shown in FIG. 5, and a three-dimensional diagram of the touch window in FIG. 5 is shown in FIG. 6. The touch window 200 includes a first transparent substrate 110, a second transparent substrate 151, a third transparent substrate 152, three adhesive layers 121, 122a and 122b, two conductive films 191 and 192 and a pad 180.

In the present embodiment of the invention, the area of the first transparent substrate 110 is larger than that of the second transparent substrate 151, and the area of the first transparent substrate 110 is equal to that of the third transparent substrate 152. The third transparent substrate 152 and the second transparent substrate 151 are sequentially disposed on the first transparent substrate 110. The conductive film 191 is disposed on the second transparent substrate 151, and the conductive film 192 is disposed on the third transparent substrate 152. The conductive film 191 faces the conductive film 192, and several spacers 140 disposed between the conductive films 191 and 192 so as to form an interval therebetween. The adhesive layer 121 is disposed between the third transparent substrate 152 and the first transparent substrate 110 for bonding the third transparent substrate 152 and the first transparent substrate 110. The adhesive layer 121 is, for example, a double-sided adhesive, a high polymer adhesive or an optical adhesive.

The adhesive layer 122a is disposed between the second transparent substrate 151 and the third transparent substrate 152 for bonding the second transparent substrate 151 and the third transparent substrate 152, so that the conductive films 191 and 192 are located on two opposite surfaces of the adhesive layer 122. The adhesive layer 122b is disposed between the third transparent substrate 152 and the pad 180 for bonding the third transparent substrate 152 and the pad 180, so that the pad 180 and the conductive film 192 are located on two opposite surfaces of the adhesive layer 122b. The adhesive layers 122a and 122b can be made of the same or different materials. Or, the adhesive layers 122a and 122b can be formed as the same layer. The adhesive layers 122a and 122b can be an optical adhesive, a high polymer adhesive or a double-sided adhesive.

In the present embodiment of the invention, the pad 180 adjacent to the second transparent substrate 151 is disposed on the first transparent substrate 110 through the adhesive layer 122b, the conductive film 192, the third transparent substrate 152 and the adhesive layer 121. The pad 180 can be made of an easy-to-process material such as plastics or glass.

Preferably, the conductive film 192 in FIG. 5 has the same shape and area as the first transparent substrate 110. In the present embodiment, the conductive film 192 is disposed on the third transparent substrate 152. However, the conductive film 192 can be directly formed on the first transparent substrate 110. Referring to FIG. 7, the conductive film directly formed on the first transparent substrate is shown. The opaque layer 110b is disposed on the top surface of the first transparent substrate 110. Besides, the top surface of the first transparent substrate 110 further has a protection layer such as silicon dioxide (SiO₂) plated thereon. The second transparent substrate 151 and the pad 180 can be bonded on one side of the first transparent substrate 110 through the adhesive layers 122a and 122b, respectively. Thus, the touch window 200′ does not need to have the third transparent substrate 152 and the adhesive layer 121 (indicated in FIG. 5 and FIG. 6) so as to reduce the thickness of the touch window 200′. In another embodiment, the opaque layer 110b can be disposed on the bottom surface of the first transparent substrate 110. Furthermore, an insulating layer (not illustrated) is disposed under the opaque layer 110b for providing the evenness and blocking metal particles of the opaque layer 110b to avoid the electrical properties of the conductive film 192 being affected.

### Third Embodiment

The present embodiment of the invention differs from the first embodiment in the size, number and disposition of a conductive film and transparent substrates. As for other components and steps, the same numbers are used and are not repeatedly described herein.

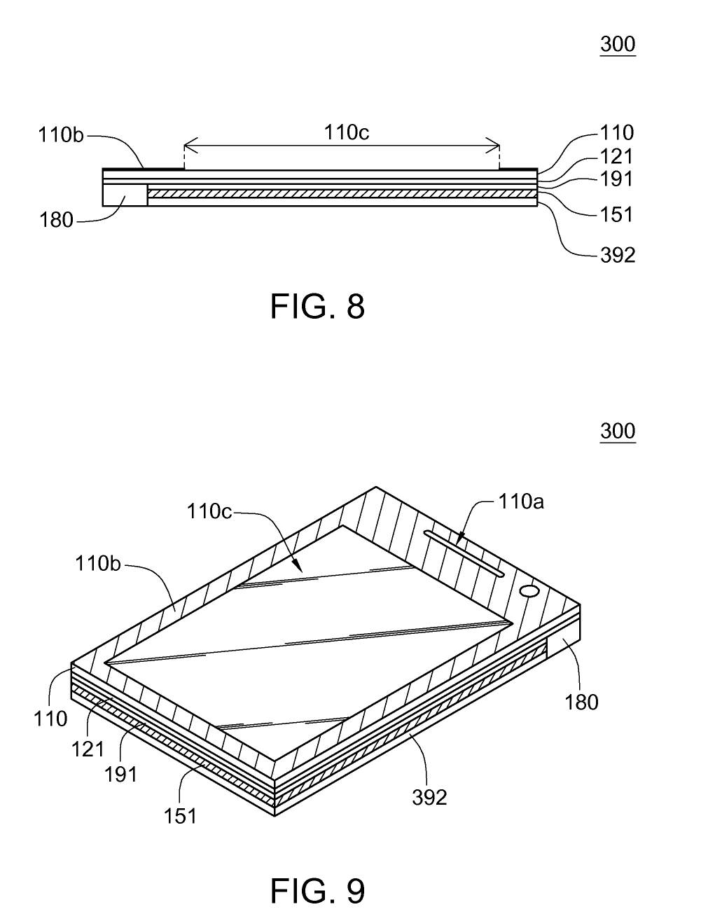

Referring to both FIG. 8 and FIG. 9, a touch window according to a third embodiment of the present invention is shown, and a three-dimensional diagram of the touch window in FIG. 8 is shown.

The touch window 300 includes a first transparent substrate 110, a second transparent substrate 151, an adhesive layer 121, a conductive film 191 and a pad 180.

In the present embodiment of the invention, the area of the first transparent substrate 110 is larger than that of the second transparent substrate 151. The adhesive layer 121 is disposed between the second transparent substrate 151 and the first transparent substrate 110 for bonding the second transparent substrate 151 and the first transparent substrate 110. The adhesive layer 121 is, for example, an optical adhesive, a high polymer adhesive or a double-sided adhesive. The conductive film 191 is disposed on the second transparent substrate 151 and is located between the first transparent substrate 110 and the second transparent substrate 151. The pad 180 is, for example, adjacent to the second transparent substrate 151 and is disposed on the first transparent substrate 110 through the adhesive layer 121.

According to the requirements of the product design, the conductive film 191 of the present embodiment of the invention can be processed by chemical etching, laser etching or yellow light etching process to obtain the required sample, and another conductive film 392 can be disposed on the other surface of the second transparent substrate 151 opposite to the conductive film 191 according to the different application. The touch window 300 can further includes two silicon dioxide layers (not illustrated) respectively covering the conductive films 191 and 392. The two silicon dioxide layers are used for protecting the conductive films 191 and 392 to prolong the lifespan and durability of the product. Besides, in the present embodiment of the invention, the conductive films 191 and 392 can be, for example, respectively formed on two opposite surface of the second transparent substrate 151 by sputtering or evaporating.

With the disposition of the pad and transparent substrates, the touch window of the above embodiments of the present invention enables the components disposed under the touch window to be exposed through the vias at the first transparent substrate and the pad. As vias do not need to be formed at the second transparent substrate or/and the third transparent substrate by cutting, so that the complexity of the manufacturing process is simplified. In addition, both the efficiency and yield of the manufacturing process are increased. Moreover, by changing the size of the first transparent substrate and the disposition of the pad, the touch window can be used in products with different specifications so as to largely increase the flexibility application of the touch window and save the manufacturing time and cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch window, comprising:
a first transparent substrate;
a second transparent substrate disposed on one side of the first transparent substrate, wherein the area of the first transparent substrate is larger than that of the second transparent substrate;
a first conductive film disposed on the second transparent substrate and located between the first transparent substrate and the second transparent substrate; and
a pad disposed on the same side of the first transparent substrate as the second transparent substrate being disposed.

2. The touch window according to claim 1, further comprising:
an adhesive layer disposed between the first transparent substrate and the first conductive film for bonding the first transparent substrate and the first conductive film and for bonding the pad and the first transparent substrate.

3. The touch window according to claim 2, further comprising:
a second conductive film disposed on the second transparent substrate, wherein the first conductive film and the second conductive film are located on two opposite surfaces of the second transparent substrate, respectively.

4. The touch window according to claim 1, further comprising:
a second conductive film disposed between the first transparent substrate and the first conductive film;
a first adhesive layer disposed between the first conductive film and the second conductive film for bonding the first conductive film and the second conductive film; and
a second adhesive layer disposed between the pad and the second conductive film for bonding the pad and the second conductive film.

5. The touch window according to claim 4, wherein the first adhesive layer and the second adhesive layer are made of the same material.

6. The touch window according to claim 4, wherein the first adhesive layer and the second adhesive layer are formed as the same layer.

7. The touch window according to claim 4, further comprising:
a third transparent substrate disposed between the second conductive film and the first transparent substrate.

8. The touch window according to claim 7, wherein the area of the first transparent substrate is equal to that of the third transparent substrate.

9. The touch window according to claim 7, further comprising:
a third adhesive layer disposed between the first transparent substrate and the third transparent substrate for bonding the third transparent substrate and the first transparent substrate.

10. The touch window according to claim 4, further comprising:
a plurality of spacers disposed between the first conductive film and the second conductive film so as to form an interval therebetween.

11. The touch window according to claim 1, further comprising:
a third transparent substrate located between the first transparent substrate and the second transparent substrate;
a first adhesive layer disposed between the first transparent substrate and the third transparent substrate for bonding the first transparent substrate and the third transparent substrate and for bonding the pad and the first transparent substrate; and
a second conductive film disposed on the third transparent substrate, wherein the second conductive film faces the first conductive film;
wherein, the area of the first transparent substrate is larger than that of the third transparent substrate.

12. The touch window according to claim 11, wherein the pad is adjacent to or surrounds the second transparent substrate and the third transparent substrate.

13. The touch window according to claim 11, further comprising:
a second adhesive layer disposed between the second transparent substrate and the third transparent substrate for bonding the second transparent substrate and the third transparent substrate, so that the first conductive film and the second conductive film are bonded on two opposite surfaces of the second adhesive layer, respectively.

14. The touch window according to claim 1, wherein the pad is adjacent to or surrounds the second transparent substrate.

15. The touch window according to claim 1, wherein the first transparent substrate has a light transmitting area which substantially corresponds to the second transparent substrate.

16. The touch window according to claim 1, wherein the pad is made of an easy-to-process material.

17. The touch window according to claim 16, wherein the easy-to-process material is plastics or glass.

18. The touch window according to claim 1, wherein the first transparent substrate comprises one of a flexible material and a hard transparent material.

19. The touch window according to claim 18, wherein the flexible material is poly-ethylene terephthalate (PET).

20. The touch window according to claim 18, wherein the hard transparent material is glass or plastics.

21. The touch window according to claim 1, wherein the touch window comprises a plurality of pads.
